(19) United States
(12) Patent Application Publication
(10) Pub. No.: US 2007/0006514 A1
(43) Pub. Date: Jan. 11, 2007

(54) Simulated wounded-bird decoy apparatus

(76) Inventors: Richard A. Fiore, Tucson, AZ (US); Gregory Huebl, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 11/531,635

(22) Filed: Sep. 13, 2006

Related U.S. Application Data
(63) Continuation-in-part of application No. 11/050,485, filed on Feb. 2, 2005.

(51) Int. Cl. A01M 31/06

(52) U.S. Cl. 43/2

(57) ABSTRACT

A decoy apparatus and animal attraction method including a head and body formed to resemble a bird, a rotatable motor-driven shaft protruding from at least one side of the body, a wing coupled to the shaft, and a power source such that activation of the power source causes the wing structure to rotate. The wing is coupled to the shaft at an angle relative to the main axis of rotation to best simulate a broken or injured wing during rotation. The method involves only one wing of the decoy rotating to approximate the motion of a bird that has an injured wing and cannot take off.

### REFERENCE TO RELATED APPLICATION

This application is a continuation-in-part of application Ser. No. 11/050,485 filed Feb. 2, 2005 by Richard A. Fiore et al. for “Simulated Wounded-Bird Decoy Apparatus”.

### BACKGROUND OF THE INVENTION

1. Field of the Invention

This invention relates generally to devices and methods that simulate wounded prey as a means for attracting an animal and more particularly to a decoy apparatus and method that simulates a wounded bird through a mechanically driven, rotating wing.

2. Description of the Related Art

Many decoys and animal attractants of various types exist that enable a user to attract an animal for viewing, study, or hunting. Among these, chemical attractants, devices that mimic bird or other animal calls, and physical decoys are especially well known.

For example, U.S. Pat. No. 6,484,431 by Price, Sr. et al. discloses bird-like decoy devices that include wind-driven wings that are fashioned as propellers in order to be rotated by the wind. Moreover, U.S. Pat. No. 6,092,323 by McBride et al. discloses a decoy apparatus with motor-driven “blade wing” assemblies attached to a fowl-like body. While both of these inventions are designed to provide the illusion of a bird in flight, neither the paddle-like “blade wings” of McBride et al.'s invention nor Price, Sr. et al.'s “propeller-like wings” results in a realistic depiction of motion that mimics a wounded bird.

More elaborate decoys have been designed to mimic a bird with a wounded wing. For example, U.S. Patent Application Publication No. 2004/0107623 and U.S. Pat. No. 6,698,132 by Brint disclose a bird apparatus suspended from a pole, with the apparatus featuring wings that mechanically “flap.” The wings are foldable so that one or both will “vibrate” rather than “flap,” thereby providing an appearance of distress.

Due to the flapping motion of Brint's apparatus, the bird decoy must be mounted on a rod or hung in the air in order to achieve its intended purpose of flight simulation. Moreover, Brint teaches that using his apparatus to mimic injury or panic is preferably accomplished by mounting the device on a spring or (for an attenuated effect) directly on a rod, thereby allowing the decoy to move in circles.

While the devices above may be suitable for their particular purpose, they are also relatively complicated by requiring the use of a stand or hanging implement. Moreover, none of the aforementioned inventions describes a decoy apparatus that simulates an injury or distress through the use of rotational wing movement.

Thus, there remains a need in the art for a decoy apparatus and animal attraction method that mimic the motion of an injured bird (rather than of a bird flying), that are less complex then typical motorized decoys, and that are more adaptable to a variety of placement situations in that they do not require the use of a stand or suspension implement.

### SUMMARY OF THE INVENTION

The invention relates in general to a decoy apparatus including a body and head member formed to resemble a bird, a rotatable motor-driven shaft protruding from a side of the body and head member, a wing structure coupled to the motor-driven shaft, and a source of power. In one embodiment, the wing structure is coupled to the motor-driven shaft such that activation causes the entire wing structure, or a major part or majority of the wing structure, i.e., more than 50% of the wing structure, to rotate at an angle greater than zero and less than ninety degrees relative to the main axis of rotation of said motor-driven shaft, thereby producing motion that simulates an injured wing. One embodiment of the invention features a universal joint that couples the wing structure to the rotating shaft, thereby producing rotation at an angle to the main axis of rotation and a “flopping motion” that simulates wing injury graphically well.

In another embodiment, the invention further includes a clamp on the body and head portion for attaching the decoy apparatus to an object, such as a tree branch. Preferably, the clamp is disposed on the bottom of the decoy such that the apparatus is kept in a substantially upright position when attached to something. However, the decoy of the invention can also be placed on the ground on its side to great effect in simulating an injured bird.

In still another embodiment, the power source is a battery compartment that is covered by a removable strap, thereby allowing for easy access in order to activate or stop wing rotation. The strap may be removable at one (i.e., hinged) or at both ends. Preferably, a material such as a hook-and-loop fastener is used to attach the strap to the body and head member.

Yet another embodiment of the invention includes a non-rectangular wing structure to approximate the look and motion of a broken or partially missing wing. Preferably, the non-rectangular wing structure includes a triangular flap.

In yet still another embodiment of the invention, a decoy apparatus including a body and head member formed to resemble a bird, a motor-driven shaft protruding from the side of the decoy, a first wing structure coupled to the motor-driven shaft, and a second, non-rotating wing structure coupled to the body and head portion and substantially opposite in location to that of the first wing structure, is provided.

According to a method of the invention, a decoy apparatus having a body and head member formed to resemble a bird, a motor-driven shaft coupled to a wing structure, and a power source is positioned in a particular location and activated so that a single wing rotates, thereby mimicking a wounded bird in distress or that cannot take off.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 schematically depicts a first embodiment of the invention in elevational side view.

FIGS. 2A and 2B schematically illustrate wing configurations of the prior art in front elevational view.

FIG. 3 schematically illustrates a second embodiment of the invention in elevational front view and depicts in phantom line an example of wing-structure motion.

FIG. 4 depicts a third embodiment of the invention in cross-sectional view, with the two halves of the embodiment arranged as mirror images of each other.

FIG. 5 depicts a fourth embodiment of the invention in perspective view.

FIG. 6 schematically illustrates the embodiment of FIG. 3 in use according to a method of the invention.

FIG. 7 schematically illustrates another embodiment of the invention featuring a universal joint.

FIG. 8 schematically illustrates a second embodiment of the invention that features a universal joint.

### DETAILED DESCRIPTION OF THE PREFERRED EMBODIMENTS

The invention generally relates to a decoy apparatus that simulates an injured bird through the rotation of a motor-driven shaft coupled with a wing member. More specifically, the invention relates to a body and head member that contains a rotatable motor-driven shaft protruding from a side, a wing structure coupled to the motor-driven shaft, and a power source. Preferably, the wing structure is coupled to the motor-driven shaft such that the entire wing structure, or a major part or majority of the wing structure, i.e., more than 50% of the wing structure, rotates at an angle greater than zero and less than ninety degrees relative to the main axis of rotation.

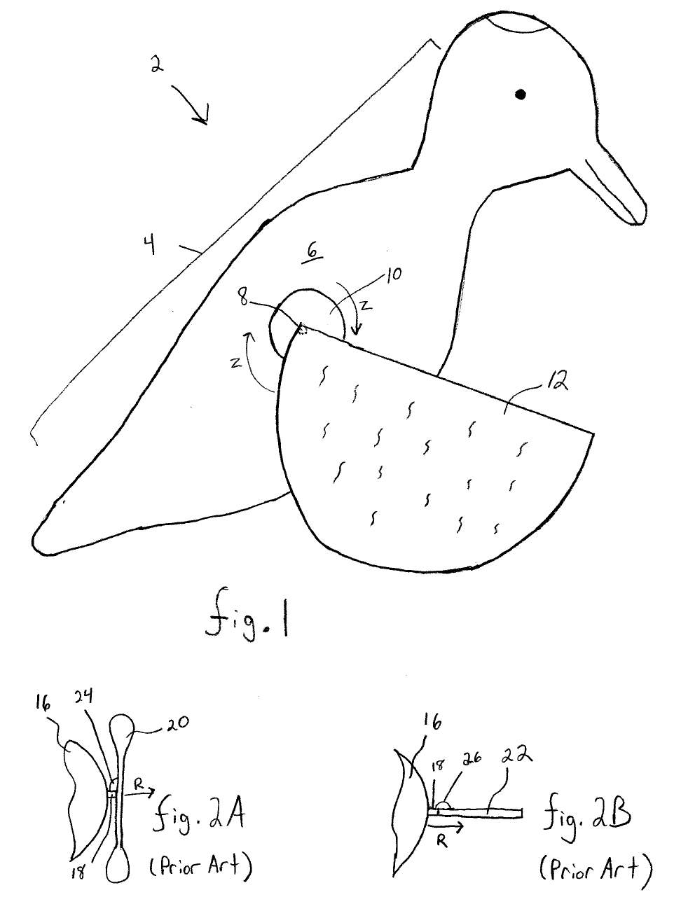

Turning to the figures, wherein like numeric references indicate like components, FIG. 1 illustrates a first embodiment of the invention. Decoy apparatus 2 includes a body and head member 4 fashioned to resemble a bird. Preferably, the body and head member 4 is integrally formed from a light weight material, such as high-density polyester foam or injection molded plastic. Protruding from a side 6 of body and head member 4 is the rotatable shaft 8 of motor 10, which is energized by a power source (not shown in this view). Coupled to shaft 8 is a wing member 12, which rotates as urged by shaft 8 and indicated by arrows Z.

It has been observed that rectangular or propeller shape wings appear to “flap” when rotated, thereby simulating a flight or take-off motion. Accordingly, wing member 12 preferably is non-rectangular due to the observation by the inventors that rotation of non-rectangular shapes provides a motion that appears to look more like a folded or injured wing and less like a bird in flight, thereby enhancing the animal attraction aspects of the invention (particularly for predators, such as foxes, bobcats, coyotes, and the like).

As seen in subsequent front-view figures and described in more detail below, the rotatable motor-driven shaft 8 protruding from the side 6 of body and head member 4 defines a main axis of rotation (as observed from a perspective other than a side view, e.g., a front or back view), such that a wing structure can be coupled to the shaft in a manner which permits the entire wing structure, or the major part or majority of the wing structure, i.e., more than 50% of the wing structure, to rotate at an angle relative to that main axis of rotation.

With these definitions in mind, FIGS. 2A and 2B show two angles of rotation found in the prior art. Decoy body 16 has a rotatable shaft 18 that is coupled to a wing structure 20 (FIG. 2A) or 22 (FIG. 2B). Wing structure 20 is disposed upon shaft 18 at an angle 24 of ninety degrees relative to the main axis of rotation R of shaft 18. On the other hand, wing structure 22 is co-linear with shaft 18 by being disposed upon shaft 18 at an angle 26 of one hundred and eighty degrees relative to axis of rotation R.

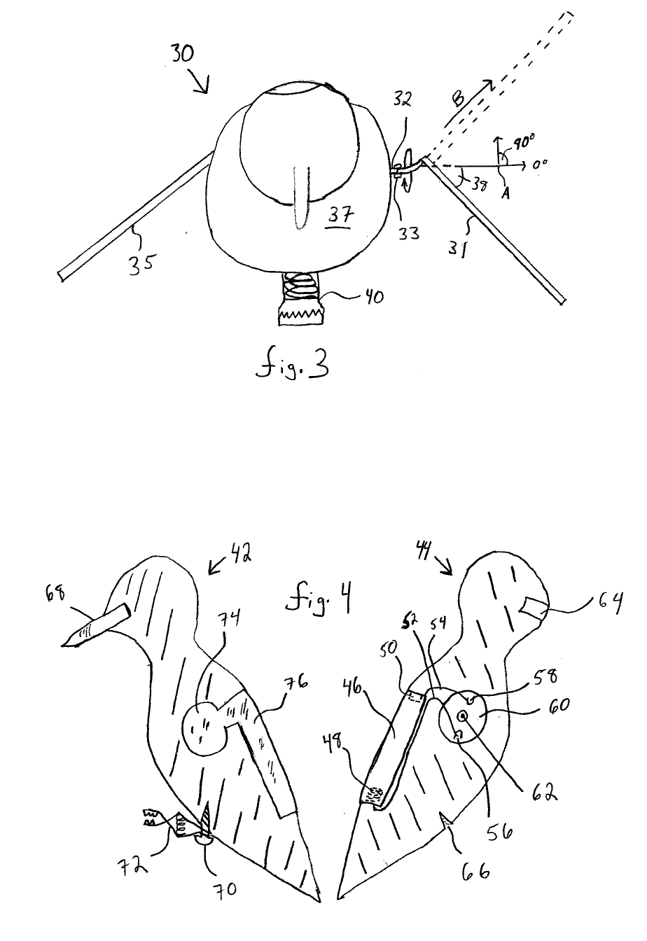

Turning to FIG. 3, a decoy 30 of the invention is illustrated that includes a first wing structure 31 coupled to a rotatable shaft 32 via weld 33 and a second, non-rotating wing structure 35. First wing structure 31 and second wing structure 35 are disposed on substantially opposite sides of body 37 to simulate actual wings. Shaft 32 has a main axis of rotation A that is co-linear therewith as shown. Because at least the major part or majority of first wing member 31, i.e., more than 50% of first wing member 31, is disposed at an angle 38 greater than zero and less than ninety degrees relative to the main axis of rotation A, the rotation of first wing member 31 appears to indicate a folded, clipped, or otherwise irregular or injured wing that draws the attention of other animals. The angle 38 is preferably in the range of 5 to 85 degrees. Decoy 30 further includes a clamp 40 located on the bottom of body 37. The clamp 40 allows the placement of decoy 30 in an upright position on a tree branch, in a nest, and in a variety of other locations.

As seen in mirror cross-sections 42 and 44 of FIG. 4, the invention preferably provides rotation to a wing structure through a battery 46, terminals 48 and 50, terminal wires 52 and 54 connecting the terminals 48 and 50 with poles 56 and 58 on electric motor 60, and a rotatable shaft 62 that is rotated by motor 60. Section 44 further contains spaces or hollow sections 64 and 66 for receiving bill 68 and fastener 70 of clamp 72, respectively. Conversely, section 42 contains spaces or hollow sections 74 and 76, which are adapted to receive battery 46, wires 52 and 54, and motor 60.

FIG. 5 illustrates in perspective view another embodiment of the invention that features a triangular flap 80 coupled with rotatable shaft 82. Shown in phantom line are motor 84, wires 86 and 88, and battery compartment 90, which are housed inside the body 91. The power source, which is a battery 92 in this case, is covered by a removable flap 94. Clamp 96 is disposed substantially at the bottom of body 91 to support the decoy upright at a desired location.

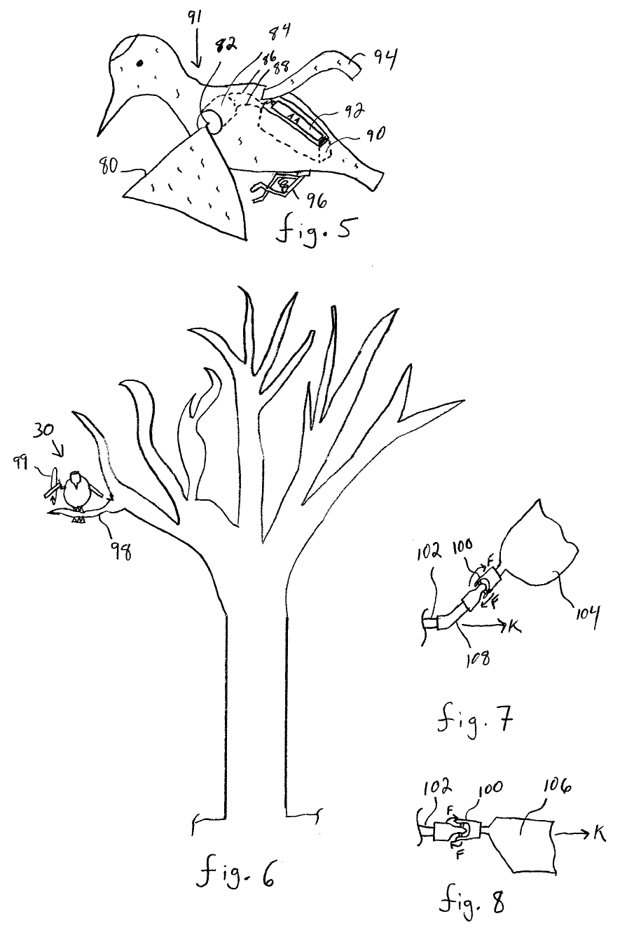

Turning to FIG. 6, the decoy apparatus 30 of FIG. 3 is shown attached to a tree branch 98. According to the method of the invention, one wing is set in rotational motion 99 to simulate a bird that is in distress or that has an injured wing.

Turning to FIGS. 7 and 8, a universal joint 100 is used in another embodiment of the invention to provide an extra “flopping” motion (arrows F) at an angle relative to the main axis of rotation K. Universal joint 100 is a flexible coupling used to join rotating shafts 102 to wing members 104 and 106, either directly or through an extender 108. While other types of universal joints may be used with the invention, a typical universal joint will feature ends that form U-shaped yokes that dovetail into each other and pivot flexibly about a pivot point. This construction allows side-to-side and up-and-down movement, while still transmitting rotary motion.

In view of the disclosure above, it is readily seen that the invention is especially useful for attracting animals by simulating a bird in distress.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. A decoy apparatus, comprising:
a body and head member formed to resemble a bird;
a rotatable motor-driven shaft protruding from a side of said body and head member, said motor-driven shaft defining a main axis of rotation extending transversely of said body and head member;
a wing structure coupled to said motor-driven shaft, said wing structure having a major part; and
a power source coupled to said motor-driven shaft;
wherein said main axis of rotation extends at an angle greater than zero and less than ninety degrees relative to said major part of said wing structure.

2. The decoy apparatus of claim 1, wherein said body and head member includes a clamp for attaching the decoy apparatus to an object.

3. The decoy apparatus of claim 2, wherein said clamp is disposed upon said body and head member such that the decoy apparatus is kept substantially upright when said clamp is attached to the object.

4. The decoy apparatus of claim 1, wherein said power source comprises a battery compartment covered by a removable strap.

5. The decoy apparatus of claim 1, wherein said wing structure is non-rectangular.

6. The decoy apparatus of claim 1, wherein said wing structure comprises a triangular flap.

7. The decoy apparatus of claim 1, wherein said angle is between 5 and 85 degrees.

8. The decoy apparatus of claim 1, wherein a universal joint is disposed between the motor-driven shaft and the wing structure.

9. A decoy apparatus, comprising:
a body and head member formed to resemble a bird;
a rotatable motor-driven shaft protruding from a side of said body and head member;
a first wing structure coupled to said motor-driven shaft;
a second wing structure coupled to said body and head member substantially opposite said first wing structure, said second wing structure being attached to said body and head member in a predetermined position and being substantially immovable out of said predetermined position; and
a power source coupled with said motor driven shaft.

10. The decoy apparatus of claim 9, wherein said body and head member includes a clamp for attaching the decoy apparatus to an object.

11. The decoy apparatus of claim 10, wherein said clamp is disposed upon said body and head member such that the decoy apparatus is kept substantially upright when said clamp is attached to the object.

12. The decoy apparatus of claim 9, wherein said power source comprises a battery compartment covered by a removable strap.

13. The decoy apparatus of claim 9, wherein said first wing structure is non-rectangular.

14. The decoy apparatus of claim 9, wherein said first wing structure comprises a triangular flap.

15. The decoy apparatus of claim 9, wherein said first wing structure has a major part and said motor-driven shaft defines a main axis of rotation extending transversely of said body and head member at an angle greater than zero and less than ninety degrees relative to said major part of said first wing structure.

16. The decoy apparatus of claim 15, wherein said angle is between 5 and 85 degrees.

17. The decoy apparatus of claim 9, wherein a universal joint is disposed between the motor-driven shaft and the first wing structure.

18. A method for attracting animals, comprising the steps of:
(a) positioning a decoy which includes a body and head member formed to resemble a bird, a first wing structure to one side of said body and head member, and a second wing structure to an opposite side of said body and head member; and
(b) rotating one of said wing structures on a main axis of rotation extending transversely of said body and head member while maintaining the other of said wing structures substantially stationary thereby mimicking a wounded bird and attracting an animal.

19. The method of claim 18, wherein said one wing structure has a major part and said main axis of rotation extends at an angle greater than zero and less than ninety degrees relative to said major part of said one wing structure.

20. The method of claim 19, wherein said angle is between 5 and 85 degrees.

21. The method of claim 18, wherein said one wing structure is non-rectangular.

22. The method of claim 18, wherein said one wing structure comprises a triangular flap.

23. The method of claim 18, wherein said one wing structure is rotated by a driven shaft and a universal joint is disposed between said driven shaft and said one wing structure.
